(19) United States
(12) Patent Application Publication
(10) Pub. No.: US 2016/0307236 A1
(43) Pub. Date: Oct. 20, 2016

(54) COST-PER-VIEW ADVERTISEMENT BIDDING

(71) Applicant: AppNexus, Inc., New York, NY (US)

(72) Inventor: Arel Ives Lidow, New York, NY (US)

(21) Appl. No.: 14/685,919

(22) Filed: Apr. 14, 2015

(51) Int. Cl. G06Q 30/02

(52) U.S. Cl. CPC G06Q 30/0275

(57) ABSTRACT

Methods, systems, and apparatus, including computer programs encoded on a computer storage medium, for receiving from a client device a first notification of an ad space of an ad space inventory, the ad space included in a user interface of an application on the client device, sending to bidders a second notification requesting bids on the ad space, receiving bids from the bidders, identifying a first bid of the received bids corresponding to a first buyer and a first bid price of a cost-per-view price wherein the first buyer pays the first bid price only if the creative is viewed, adjusting the first bid price based on a historical viewing rate of ad spaces of the ad space inventory, ranking the bids according to respective bid prices wherein the first bid is ranked according to the adjusted first bid price, and selecting a top-ranked bid.

### BACKGROUND

This specification relates to advertising and, in particular, cost-per-view bids for online advertising auctions.

Online display advertising delivers promotional messages to consumers by using visual advertisements (or “ads”) in web pages. A publisher of a web page can insert an ad space in a web page. An ad space is a region of a web page (or other electronic document) where an advertisement can be placed. When the web page is displayed in a browser, a visual advertisement (a “creative”) of an advertiser can be dynamically retrieved from an ad server for the advertiser, and displayed in the ad space. The act of serving a creative on a web page for displaying is often referred to as an impression.

An ad space inventory is a collection of one or more ad spaces on web pages served by a publisher's web sites. Publisher can sell their ad space inventories to advertisers. Multiple publishers and multiple advertisers can participate in auctions in which selling and buying of ad space inventories take place. Auctions can be conducted by an ad network or ad exchange that brokers between a group of publishers and a group of advertisers.

Selling and buying ad spaces can be based on pricing or payment models such as cost per thousand impressions (CPM), cost per view (CPV), cost per click (CPC), and cost per action or acquisition (CPA). In the CPM model, advertisers typically pay for every impression of their advertisement; the price paid for each impression is measured in price per 1000 (“mille”) impressions. In the CPV model, advertisers typically pay each time their advertisement is viewed by a user. In the CPC model, advertisers typically pay each time a viewer clicks on their advertisement. In the CPA model, advertisers pay for every action, such as a sale or registration, completed as a result of a viewer clicking on their advertisement.

### SUMMARY

In general, one aspect of the subject matter described in this specification can be embodied in methods that include the actions of receiving from a client device a first notification of an ad space of an ad space inventory, the ad space being for presentation in a user interface of an application executing on the client device, sending, to a plurality of bidders, a second notification requesting a bid on the ad space, each bidder representing a respective buyer, receiving bids from the bidders, each bid corresponding to a respective buyer, a respective creative, and a respective bid price, identifying a first bid of the received bids corresponding to a first buyer and a first bid price, the first bid price being a CPV price wherein the first buyer pays the first bid price only if the creative is viewed, adjusting the first bid price based on a historical viewing rate of ad spaces of the ad space inventory, ranking the bids according to respective bid prices wherein the first bid is ranked according to the adjusted first bid price, and selecting a top-ranked bid. Other embodiments of this aspect include corresponding systems, apparatus, and computer programs.

These and other aspects can optionally include one or more of the following features. The aspect can further comprise selecting the first bid as the top-ranked bid, causing a first creative to be served to the ad space, receiving a first confirmation of viewing of the first creative by a user, and recording a transaction comprising the seller, the first buyer, and the first bid price before adjustment. The first creative can include tracking code. The first confirmation can be based on processing, by the user interface, the tracking code to generate one or more pixels for presentation in the ad space in the user interface. The first confirmation can be based on the first creative has been presented in the user interface for a time period that exceeds a time period specified by the first buyer. The first confirmation can be based on at least a percentage area of the first creative has been presented in the user interface, the percentage being specified by the first buyer. The adjusting the first bid price can further comprise applying a risk factor to the first bid price. The risk factor can be configured to raise the first bid price and compensate for a probability that: (i) the first bid is selected as the top-ranked bid, and (ii) no confirmation is received for viewing of a first creative of the first buyer that is served to the ad space. The bids can further comprise a second bid corresponding to a second buyer and a second bid price, the second bid price being a cost-per-impression price wherein the second buyer pays the second bid price when a creative for the second buyer is served to the ad space.

Particular implementations of the subject matter described in this specification can be implemented to realize one or more of the following advantages. The system described herein accepts bids with both cost-per-impression and cost-per-view bid prices for an auction of an ad space. In order to ensure a fair comparison between the cost-per-impression bid prices and cost-per-view bid prices, the system translates a bid's cost-per-view bid price to an expected cost-per-impression bid price based on a historical viewing rate on an ad space inventory including the ad space. For example, the system can translate the bid's cost-per-view bid price to an expected cost-per-impression bid price based on likelihood that a creative served to the ad space was not viewed by a user in the past. The system can further adjust the expected cost-per-impression bid price, by applying a risk factor to raise the expected cost-per-impression bid price and compensate for a probability that (i) the bid wins the auction, and (ii) no viewing is confirmed for a creative for the bid that is served to the ad space. The system also allows a buyer submitting a cost-per-view bid price to define one or more criteria for determining whether a creative served to the ad space is viewed by a user.

The details of one or more implementations of the subject matter described in this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 illustrates an example system for adjusting cost-per-view bid price on an ad space based on a historical viewing rate of the ad space.

FIG. 2 is a data flow diagram of an example method for adjusting cost-per-view bid price on an ad space based on a historical viewing rate of the ad space.

FIG. 3 is a flowchart of an example method for adjusting cost-per-view bid price on an ad space based on a historical viewing rate of the ad space.

Like reference numbers and designations in the various drawings indicate like elements.

### DETAILED DESCRIPTION

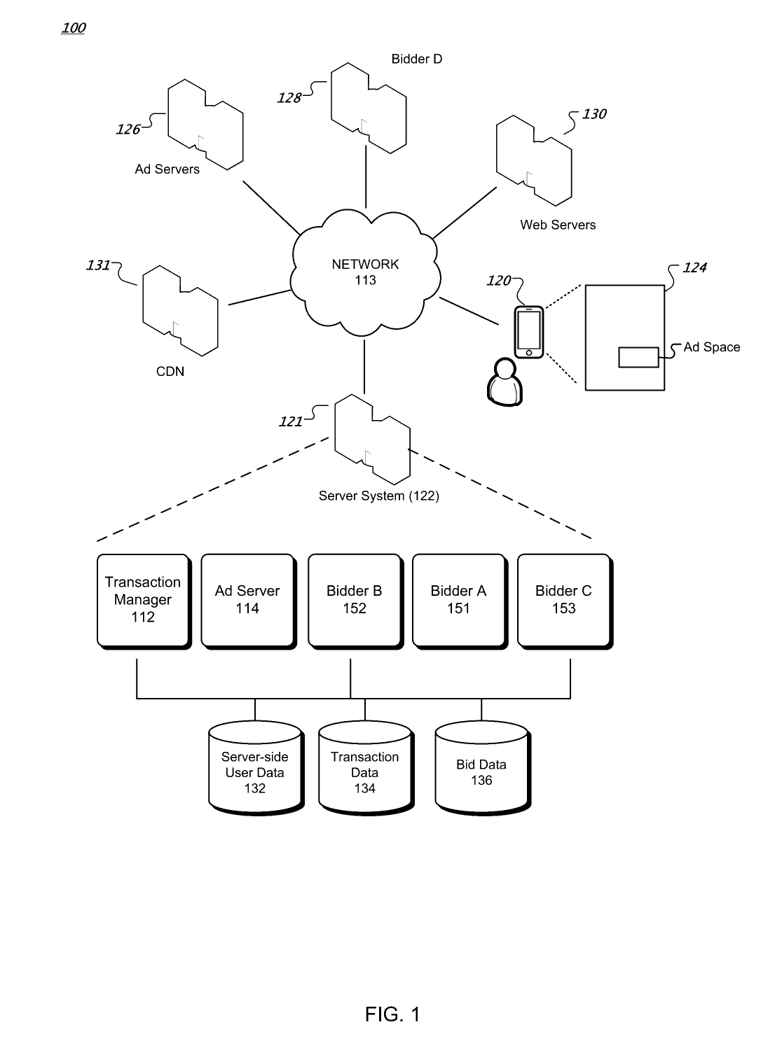

FIG. 1 illustrates an example system 100 for adjusting a CPV bid price for an ad space based on a historical viewing rate of the ad space. A server system 122 provides functionality for adjusting bid prices for display advertising auctions. The server system 122 comprises software components and databases that can be deployed at one or more data centers 121 in one or more geographic locations, for example. The server system 122 software components comprise a transaction manager 112, ad server 114, and one or more bidders (e.g., bidder A 151, bidder B 152, and bidder C 153). The server system 122 can also include one or more software components for load balancing tools and security tools. The load balancing tools manage traffic within a single data center or between multiple data centers. The security tools manage data protection and access privilege for tenants served by the data centers 121. The software components can comprise subcomponents that can execute on the same or on different individual data processing apparatus. The server system 122 databases comprise a server-side user data database 132, transaction data database 134, and bid data database 136. The databases can reside in one or more physical storage systems. The software components and databases will be further described below.

The transaction manager 112 (“impression bus” or simply “Imp Bus”) is a software component that facilitates the transaction aspects of ad space inventory trading between buyers and sellers. A buyer can be an advertiser (e.g., a credit card company, a sportswear company), an ad network, or an advertising agency. Other buyers are possible. A seller can be a publisher (e.g., newspaper or social network), an online streaming or gaming service, or an ad network. Other sellers are possible. The transaction manager 112 processes ad requests received from web browsers or other software applications displaying content from publishers, send relevant information to advertisers, conducts auctions (e.g., on behalf of sellers), returns creatives to the browsers or other applications, keeps track of billing and usage for advertisers and publishers, returns auction-result data, and enforces quality standards, for example. The transaction manager 112 stores in the transaction data database 134 various transaction information for each ad space that is transacted by the transaction manager 112 or other software components of the server system 122.

The ad server 114 is a software component that serves creatives to web pages. The ad server 114 can also make decisions about what creatives to serve, and track clicks or other user interactions with creatives, for example.

A bidder (e.g., bidder A 151) is a software component that, on behalf of a buyer, performs bidding operations. The bidder takes various pieces of bid-specific information (e.g., maximal bid price, target user areas or segments, start and end dates, budget) as input and generates a bid for a particular item of an ad space inventory, for example. The bidder may store bid-specific information in bid data database 136. In some implementations, a bidder can be remote from the server system 122, such as bidder D 128.

The transaction manager 112 can conduct an auction when receiving an ad request for filling an available ad space. By way of illustration, a user interface 124 of an application executing on a user's client device 120 can include an ad space and a corresponding ad tag. For instance, a web page displayed in a browser window of a web browser (e.g., running on a personal computer) can include an ad space on the web page and a corresponding ad tag. By way of illustration, the ad space can appear at the bottom of the user interface (a “banner ad”) with a corresponding ad tag. Other examples of ad spaces are possible. Here, the user's client device 120 can be a mobile phone, a smartwatch, a tablet computer, a personal computer, a game console, or an in-car media system. Other examples of a client device are possible.

In some implementations, an ad tag comprises a Uniform Resource Locator (URL) from which an ad will be requested (e.g., a URL for the server system 122), Hypertext Markup Language (HTML) statements and/or JavaScript instructions for retrieving and displaying a creative (e.g., displaying the creative in a 160×600 iframe). The application running on the user's client device 120 can retrieve content in the user interface 124 (e.g., a web page) through one or more data communication networks 113 such as the Internet, for example, from web servers 130 of a publisher. The ad tag causes the application to send (e.g., through the networks 113) a notification or an ad request to the server system 122. The ad request can include information about the available ad space (e.g., a size for the ad space, an identifier for the publisher), user information (e.g., an identifier of the user, an IP address), and system information (e.g., types of the browser and the client device), for example.

In response to the ad request, the transaction manager 112 can access a server-side user data database 132 based on the user's identifier (if available), and retrieve available information about the user (e.g., user segment information such as age, gender, interests, or location). The transaction manager 112 generates a bid request including information about the ad space, the user, and so on, and sends the bid request to multiple bidders such as bidder A 151 and bidder B 152. The transaction manager 112 can also send the bid request through the networks 113 to servers of bidder D 128, which is external to the server system 122.

Each bidder determine an appropriate bid based on its own requirements (e.g., budget, targets in placements or user demographics) and submit a bid response including a bid price and an identifier of a creative to be served, for example, to the transaction manager 112 (or not to respond at all). The transaction manager 112 determines a winning bid (e.g., a highest bid) among bid responses received within a specified time period (e.g., 10 milliseconds). The transaction manager 112 then returns a creative of the winning bid to the user's client device 120, causing the application to display the creative in the ad space in the user interface 124. The transaction manager 112 can also return a URL for a creative of the winning bid to the user's client device 120, causing the application on the client device 120 to retrieve the creative from an ad server (e.g., ad server 114, or ad servers 126 external to the server system 122), or from servers of a content distribution network (CDN) 131. In various implementations, the transaction manager 112 can store in the transaction data database 134 transaction information such as an identifier of the creative served to the user, an identifier of the winning buyer, the user's identifier, the winning bid price, an identifier of the ad space, an identifier of the seller of the ad space, and a time stamp. Other transaction information of a transaction is possible.

The creative served to the ad space can also include tracking code or tracking code can be sent separately from the creative. The tracking code includes program instructions (e.g., in Asynchronous JavaScript and XML or “AJAX”) that when executed send events to the transaction manager 112 when the creative is in view of the user. For instance, the tracking code can generate one or more image pixels for presentation in the ad space in the user interface 124. The tracking code (e.g., as executed by the user interface 124 or another software component running on the client device 120) can make a server call-back to the transaction manager 112 when the creative is being presented in the user interface 124—i.e., the creative is in view of the user, and retrieve an image pixel for presentation in the ad space. The image pixel itself is not necessarily visible. Other techniques for server call-back by the tracking code are possible.

The server call-back by the tracking code can also include additional information such as an identifier of the ad space, an identifier of the transaction for serving the creative, and an identifier of the user (e.g., an IP address of the client device 120). In this way, the transaction manager 112 can determined that the creative has been viewed by the user (a viewed creative) after receiving one or more server call-backs by the tracking code.

The tracking code can determine when a particular location of the creative is presented in the user interface 124. For instance, the tracking code can determine whether an element (e.g., HTML DIV or LI element) at a particular location of the creative is in view in the user interface 124. As for another example, the tracking code can analyze changes in a Document Object Model (DOM) tree structure used by the user interface 124 to determine whether a particular location of the creative is presented in the user interface 124. The tracking code can perform different server call-backs to the transaction manager 112 when detecting different corresponding locations are being presented in the user interface 124. In this way, the transaction manager 112 can determine that the creative has been viewed (entirely or partially) by the user based on a number or a percentage of the server call-backs by the tracking code.

The tracking code of the creative can make multiple numbers of server call-backs to the transaction manager 112 at different time instances. For instance, the tracking code can make a first server call-back to the transaction manager 112 when the creative is presented in the user interface 124 for the first time. The tracking code can make a second server call-back to the transaction manager 112 after a specified time period (e.g., 5 seconds) if the creative is still being presented in the user interface 124. In this way, the transaction manager 112 can determine that the creative is viewed by the user of the client device 120 as having been viewed by the user for at least the specified time period, for example, based on two different requests from the tracking code, if the two requests are separated apart by the specified time period. In various implementations, the transaction manager 112 can determine whether the creative has been viewed by the user for at least the specified time period by aggregating time of separate views of the creative by the user. For instance, the transaction manager 112 can determine that the creative has been viewed by the user for 5 seconds if the transaction manager 112 receives two server call-backs (from the tracking code of the creative) that are 2 seconds apart, and another two server call-backs (from the tracking code of the creative) that are 3 seconds apart.

Based on the information (or lack thereof) from the tracking code of the creative served to the ad space, the transaction manager 112 can determine creative viewing information in that some or all of the creative is viewed by the user, or additionally a time period that the creative is viewed, for example. The transaction manager 112 can include the creative viewing information in the transaction information for the ad space that is stored in the transaction data database 132 described earlier.

In order to ensure a fair comparison between bids on an ad space, the transaction manager 112 can conduct an auction of an ad space by accepting bids with bid prices in the same cost base. For instance, the transaction manager 112 can conduct an auction of the ad space by accepting bids with cost-per-impression bid prices (the CPM model) only. For a cost-per-impression bid price, the winning buyer pays the bid price when the winning buyer's creative is served to the ad space. However, some potential buyers may prefer bidding based on CPV. For a CPV bid price, the winning buyer pays the bid price when the winning buyer's creative is viewed by the user of the client device 120. To include CPV bids with cost-per-impression bids on an ad space, particular implementations translate CPV bids to expected cost-per-impression bids. More particularly, a CPV bid on an ad space is adjusted based on a historical viewing rate on the ad space, as further described below.

As described earlier, the transaction manager 112 may receive, from the client device 120, an ad request for an available ad space in a web page presented in the user interface 124. The ad space is part of an ad space inventory that is a collection of ad spaces on web pages served by one or more web sites. For instance, an ad space inventory can include ad spaces on web pages served by nytimes.com (by The New York Times in New York, N.Y.). As another example, an ad space inventory can include ad spaces on web pages served by sports-related websites. In another example, an ad space inventory can include ad spaces presented by a software application (e.g., a game application) in its user interface. The transaction manager 112 then sends to a plurality of bidders (e.g., bidders 151, 152, 153, or 128) a request for bidding on the ad space. The transaction manager 112 can include in the request a flag (e.g., an integer value) in the bid request indicating that CPV bids are accepted, in addition to cost-per-impression bids.

The bidders (e.g., bidders 151, 152, 153, or 128) can send bids to the transaction manager 112 in response to the bid request. Each bid corresponds to a respective buyer, a respective bid price, and a respective creative (or a link to a creative). Each bid can also include a bid type field indicating whether its bid price is a cost-per-impression bid price or a CPV bid price. The bids received by the transaction manager 112 can include CPM bids (each with a CPM bid price) and CPV bids (each with a CPV bid price).

In various implementations, the transaction manager 112 identifies a bid with a CPV bid price (e.g., based on the bid's bid type) and translates the CPV bid price to an expected cost-per-impression (eCPM) bid price. The transaction manager 112 can translate the CPV bid price to an eCPM bid price by adjusting the CPV bid price based on a historical viewing rate of a particular ad space inventory including the ad space for a given time period. For instance, the transaction manager 112 can access the transaction data database 134 for transaction information for ad spaces in the particular ad space inventory. From the transaction information and creative viewing information included in the transaction information, the transaction manager 112 can determine a number of creatives that were served to ad spaces of the particular ad space inventory (e.g., over the past week), and among the served creatives a number of creatives that were also viewed by users. The transaction manager 112 then determines a historical viewing rate (for ad spaces of the particular ad space inventory) as the ratio of the number of viewed creatives to the number of served creatives, as listed in EQUATION 1 below:

$$historical viewing rate = \frac{number of viewed creatives}{number of served creatives} \qquad ( EQUATION 1 )$$

As described earlier, the transaction manager 112 can determine whether a creative served to an ad space is a viewed creative based on one or more serve call-backs by tracking code of the creative. More particularly, a buyer can specify (e.g., using a field in the bid response) a criteria for a viewed creative used in EQUATION 1 above. For instance, the buyer can specify criteria for a viewed creative if the entire creative was viewed. For another example, the buyer can specify criteria for a viewed creative if the creative was viewed for at least two seconds. As for yet another example, the buyer can specify criteria for a viewed creative if 50% of the creative's area was viewed for at least five seconds. The buyer can also specify a past time period (e.g., past two weeks) for which the number of viewed creatives and the number of served creatives are obtained and used to calculate the historical viewing rate in EQUATION 1 above. In some implementations, the seller can specify criteria for a viewed creative, if it is not specified by the buyer. The seller can also specify criteria for a viewed creative but does not allow the buyer to change the criteria. In this case, the transaction manager 112 can include in the bid requests sent to the bidders an indication about the fixed criteria set by the seller.

Based on the historical viewing rate, the transaction manager 112 adjusts the CPV bid price by, for example, multiplying the CPV bid price with the historical viewing rate, as listed in EQUATION 2 below:

adjusted bid price=CPV bid price×historical viewing rate (EQUATION 2)

For instance, assume that the CPV bid price is $0.05 for an ad space, and the historical viewing rate for an ad space inventory including the ad space is 80% (i.e., 8 out of 10 creatives served to ad spaces of the ad space inventory were actually viewed by users). Then the eCPM bid price or the adjusted bid price is $0.04 for the ad space ($0.04=$0.05×80%). That is, the CPV bid price is adjusted (“discounted”) 20% lower since there is a 20% likelihood (based on the historical viewing rate) that a creative served to the ad space is not viewed by a user. Other implementations for adjusting the CPV bid price are possible.

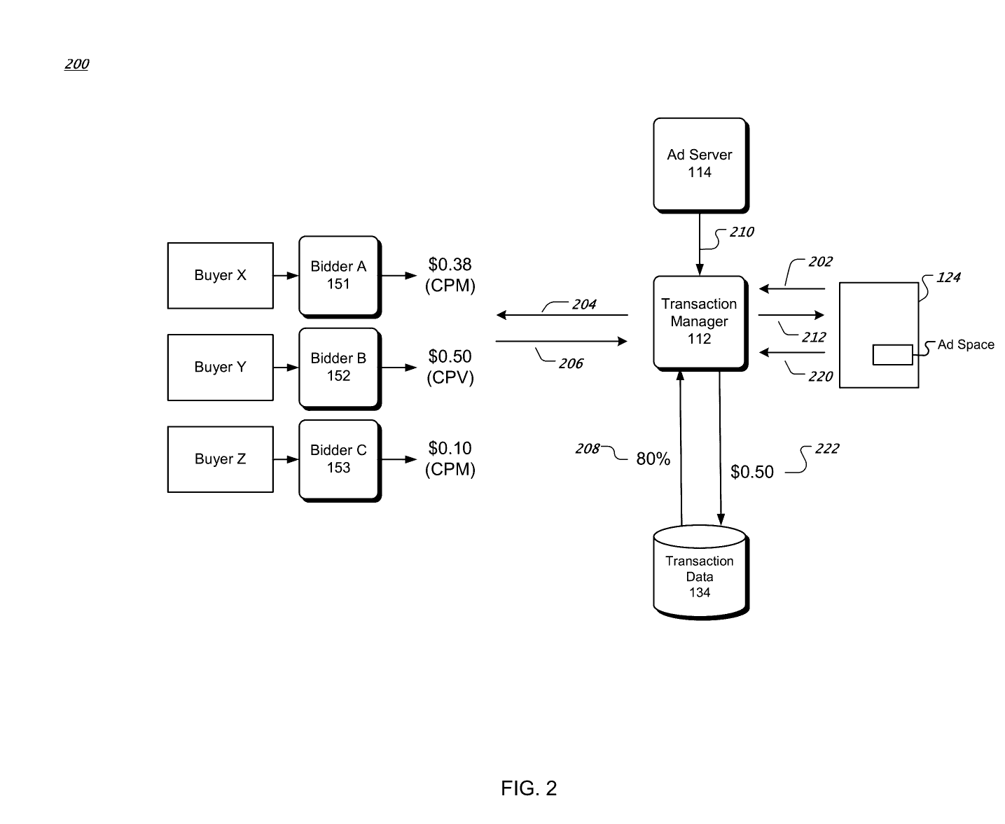

FIG. 2 is a data flow diagram of an example method for adjusting CPV bid price on an ad space based on a historical viewing rate of the ad space. In FIG. 2, the transaction manager 112 receives an ad request (202) indicating an available ad space in the user interface 124 of the application running on the client device 120. The ad request includes an identifier of the ad space. The transaction manager 112 can conduct an auction on the ad space by sending a bid request (204) to bidders in the server systems 122 (or external to the server system 122). Each bidder (e.g., bidder A, bidder B, bidder C) can bid on behalf of a respective buyer (e.g., buyer X, buyer Y, buyer Z). The transaction manager 112 can include in the bid request a flag indicating that both CPV and CPM bids are accepted.

Here, let the buyer X and buyer Z have bid prices ($0.38 and $0.10, respectively) that are CPM bid prices. Let the buyer Y has bid price ($0.50) that is a CPV bid price. As described earlier, the buyer X or Z would pay for its bid price if its bid won the auction and its creative was served to the ad space in the user interface 124. The buyer Y would pay for its bid price if its bid won the auction and its creative was served to and viewed in the ad space in the user interface 124. The bidders can include in its respective bid a bid type field indicating whether its bid price is a CPV or CPM bid price.

After receiving the bid prices (206), the transaction manager 112 identifies the bid price $0.50 from buyer Y as a CPV bid price (as indicated by the respective bid). The transaction manager 112 then accesses the transaction data database 134 for a historical viewing rate of an ad space inventory that includes the ad space to be presented in the user interface 124. Here, let the historical viewing rate of the ad space inventory be 80%. The historical viewing rate can be previously calculated and periodically updated and stored in the transaction data database 134 by the transaction manager 112 (or another software component in the server system 122), for example. After obtaining the historical viewing rate of the ad space inventory (208), the transaction manager 112 can adjust the buyer Y's CPV bid price by multiplying the CPV bid price with the historical viewing rate. The adjusted bid price (eCPM bid price) for buyer Y is $0.40 (=$0.50×80%).

The transaction manager 112 then ranks the bids: $0.38 from buyer X, $0.40 from buyer Y as adjusted by the historical viewing rate, and $0.10 from buyer Z. In this example, the transaction manager 112 selects the top-ranked bid ($0.40 from buyer Y) as the winning bid. The transaction manager 112 can cause a creative from buyer Y to be served to the ad space in the user interface 124. For instance, the transaction manager 112 can retrieve from the ad server 112 a particular creative for buyer Y (210) and provide the particular creative to the client device 120 for presentation in the ad space in the user interface 124 (212).

The particular creative served to the ad space in the user interface 124 includes tracking code. The user interface 124 can process the tracking code when the particular creative being presented (viewed) in the user interface 124, and send a server call-back (220) to the transaction manager 112.

The transaction manager 112 can confirm that the particular creative is viewed in the ad space in the user interface 124 based on the request 220. As described earlier, the transaction manager 112 can confirm that the particular creative is viewed in the ad space based on a different criteria, for example, based on whether some or all of the creative is viewed, whether the creative is viewed over a specified time period, or both. After confirming that the creative is viewed in the ad space, the transaction manager 112 records in the transaction data database 134 a completed transaction including an identifier of the transaction, an identifier for the buyer Y, the identifier of the ad space, an identifier of the creative served, and the CPV bid price $0.50 before being adjusted by the historical viewing rate (222). Here, the buyer Y will pay $0.50 to the seller of the ad space for the creative served and viewed in the ad space. In some implementations, the transaction manager 112 records the second highest bid ($0.38) for the completed transaction based on a second-price auction rule. The buyer Y will pay $0.38 to the seller for the ad space. A second-price auction rule such as Vickrey auction encourages bidders to submit true-valued bids. Other auction rules are possible. The transaction manager 112 also records in reference to the transaction in the transaction data database 134 creative viewing information (e.g., the creative has been viewed based on one or more image pixels requested by the creative).

If the transaction manager 112 does not receive a confirmation from the user interface 124 that the particular creative is viewed, then the transaction manager 112 does not store a transaction record, since buyer Y pays for the CPV bid price only if its creative is viewed in the user interface 124 according to the buyer's criteria of the percentage of the ad viewed, the time the ad was viewed, or both. However, if this happens, the seller of the ad space loses the opportunity the sell the ad space to the next highest bidder (e.g., $0.38 bid price from buyer X).

To compensate the probability that a selected bid (e.g., a top-ranked bid) is a CPV bid, and no confirmation is received for viewing of a creative of the selected bid that is served to the ad space, the transaction manager 112 can apply a risk factor to further adjust the CPV bid price. The transaction manager 112 can apply a risk factor to a CPV bid price as listed in EQUATION 3 below, for example:

adjusted bid price=CPV bid price×historical viewing rate/risk factor (EQUATION 3)

Here, the risk factor is:

risk factor=1+risk premium (EQUATION 4)

The risk premium is an additional percentage or positive number that decreases the adjusted bid price. The risk premium (and the risk factor) effectively raises a CPV bid price needed to beat out other CPM bid prices. For instance, by applying the risk factor with a 10% risk premium to the CPV bid price of $0.50 from buyer Y, the adjusted bid price is $0.36 (=$0.50×80%/1.1). In this scenario, the transaction manager 112 selects the CPM bid $0.38 from buyer X, causes a creative from buyer X to be served to the ad space in the user interface 124, and records in the transaction data database 134 a completed transaction between buyer X, the seller of the ad space, and a bid price of $0.38. Here, the CPV bid price from buyer Y needs to be greater than $0.523 (=$0.38/80%×1.1) to win over the buyer X's CPM bid price of $0.38.

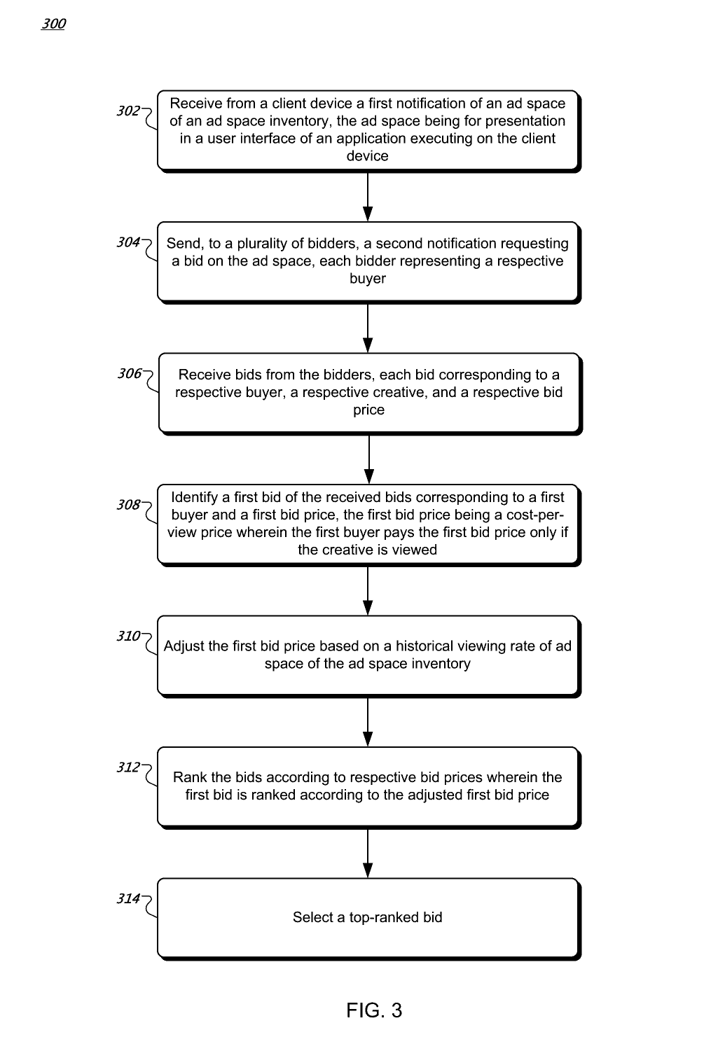

FIG. 3 is a flowchart of an example method for adjusting CPV bid price on an ad space based on a historical viewing rate of the ad space. The method can be implemented using software components (e.g., the transaction manager 112) executing on one or more data processing apparatus that are part of the data center 121 described earlier. The method begins by receiving from a client device a first notification of an ad space of an ad space inventory, the ad space being for presentation in a user interface of an application executing on the client device (step 302). The method sends, to a plurality of bidders, a second notification requesting a bid on the ad space, each bidder representing a respective buyer (step 304). The method receives bids from the bidders, each bid corresponding to a respective buyer, a respective creative, and a respective bid price (step 306). The method identifies a first bid of the received bids corresponding to a first buyer and a first bid price, the first bid price being a CPV price wherein the first buyer pays the first bid price only if the creative is viewed (step 308). The method adjusts the first bid price based on a historical viewing rate of ad spaces of the ad space inventory (step 310). The method ranks the bids according to respective bid prices wherein the first bid is ranked according to the adjusted first bid price (step 312). The method then selects a top-ranked bid (step 314).

Implementations of the subject matter and the operations described in this specification can be implemented in digital electronic circuitry, or in computer software, firmware, or hardware, including the structures disclosed in this specification and their structural equivalents, or in combinations of one or more of them. Implementations of the subject matter described in this specification can be implemented as one or more computer programs, i.e., one or more modules of computer program instructions, encoded on computer storage medium for execution by, or to control the operation of, data processing apparatus. Alternatively or in addition, the program instructions can be encoded on an artificially-generated propagated signal, e.g., a machine-generated electrical, optical, or electromagnetic signal, that is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially-generated propagated signal. The computer storage medium can also be, or be included in, one or more separate physical components or media (e.g., multiple CDs, disks, or other storage devices).

The operations described in this specification can be implemented as operations performed by a data processing apparatus on data stored on one or more computer-readable storage devices or received from other sources.

The term “data processing apparatus” encompasses all kinds of apparatus, devices, and machines for processing data, including by way of example a programmable processor, a computer, a system on a chip, or multiple ones, or combinations, of the foregoing The apparatus can include special purpose logic circuitry, e.g., an FPGA (field programmable gate array) or an ASIC (application-specific integrated circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures.

A computer program (also known as a program, software, software application, script, or code) can be written in any form of programming language, including compiled or interpreted languages, declarative or procedural languages, and it can be deployed in any form, including as a stand-alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language resource), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform actions by operating on input data and generating output. The processes and logic flows can also be performed by, and apparatus can also be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for performing actions in accordance with instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive), to name just a few. Devices suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, implementations of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending resources to and receiving resources from a device that is used by the user; for example, by sending web pages to a web browser on a user's client device in response to requests received from the web browser.

Implementations of the subject matter described in this specification can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system can include clients and servers. A client and server are generally remote from each other and typically interact through a communication network. The relationship of client and server arises by virtue of computer programs running on the respective computers and having a client-server relationship to each other. In some implementations, a server transmits data (e.g., an HTML page) to a client device (e.g., for purposes of displaying data to and receiving user input from a user interacting with the client device). Data generated at the client device (e.g., a result of the user interaction) can be received from the client device at the server.

A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions.

While this specification contains many specific implementation details, these should not be construed as limitations on the scope of any inventions or of what may be claimed, but rather as descriptions of features specific to particular implementations of particular inventions. Certain features that are described in this specification in the context of separate implementations can also be implemented in combination in a single implementation. Conversely, various features that are described in the context of a single implementation can also be implemented in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products.

Thus, particular implementations of the subject matter have been described. Other implementations are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing may be advantageous.

What is claimed is:

1. A method comprising:
performing by one or more computers:
receiving from a client device a first notification of an ad space of an ad space inventory, the ad space being for presentation in a user interface of an application executing on the client device;
sending, to a plurality of bidders, a second notification requesting a bid on the ad space, each bidder representing a respective buyer;
receiving bids from the bidders, each bid associated with a respective buyer, a respective creative, and a respective bid price;
identifying a first bid of the received bids corresponding to a first buyer, a first bid price, and a first creative, wherein the first bid price being a cost-per-view price wherein the first buyer pays the first bid price only if the first creative is viewed wherein the first creative is associated with tracking code that is configured to analyze changes to a document object model to determine whether a particular location of the creative is presented in the user interface;
adjusting the first bid price based on a historical viewing rate of ad spaces of the ad space inventory;
ranking the bids according to respective bid prices wherein the first bid is ranked according to the adjusted first bid price;
selecting the first bid as a top-ranked bid and sending the first creative and associated tracking code to the client device; and
determining that a confirmation of viewing of the first creative by a user is received and, based thereon, recording a transaction comprising the seller, the first buyer, and the first bid price before adjustment, wherein the confirmation is generated by the tracking code.

2. (canceled)

3. The method of claim 1, wherein:
the confirmation is based on processing, by the user interface, the tracking code to generate one or more pixels for presentation in the ad space in the user interface.

4. The method of claim 1, wherein the confirmation is based on the first creative having been presented in the user interface for a time period that exceeds a time period specified by the first buyer.

5. The method of claim 1, wherein the confirmation is based on at least a portion of the first creative having been presented in the user interface, the portion being specified by the first buyer.

6. The method of claim 1, wherein adjusting the first bid price further comprises:
applying a risk factor to the first bid price, the risk factor being configured to raise the first bid price and compensate for a probability that:
(i) the first bid is selected as the top-ranked bid; and
(ii) no confirmation is received for viewing of a first creative of the first buyer that is served to the ad space.

7. The method of claim 1, wherein the bids further comprise a second bid corresponding to a second buyer and a second bid price, the second bid price being a cost-per-impression price wherein the second buyer pays the second bid price when a creative for the second buyer is served to the ad space.

8. A system comprising:
one or more computers programmed to perform operations comprising:
receiving from a client device a first notification of an ad space of an ad space inventory, the ad space being for presentation in a user interface of an application executing on the client device;
sending, to a plurality of bidders, a second notification requesting a bid on the ad space, each bidder representing a respective buyer;
receiving bids from the bidders, each bid associated with a respective buyer, a respective creative, and a respective bid price;
identifying a first bid of the received bids corresponding to a first buyer, a first bid price, and a first creative, wherein the first bid price being a cost-per-view price wherein the first buyer pays the first bid price only if the first creative is viewed wherein the first creative is associated with tracking code that is configured to analyze changes to a document object model to determine whether a particular location of the creative is presented in the user interface;
adjusting the first bid price based on a historical viewing rate of ad spaces of the ad space inventory;
ranking the bids according to respective bid prices wherein the first bid is ranked according to the adjusted first bid price;
selecting the first bid as a top-ranked bid and sending the first creative and associated tracking code to the client device; and
determining that a confirmation of viewing of the first creative by a user is received and, based thereon, recording a transaction comprising the seller, the first buyer, and the first bid price before adjustment, wherein the confirmation is generated by the tracking code.

9. (canceled)

10. The system of claim 8, wherein:
the confirmation is based on processing, by the user interface, the tracking code to generate one or more pixels for presentation in the ad space in the user interface.

11. The method of claim 8, wherein the confirmation is based on the first creative having been presented in the user interface for a time period that exceeds a time period specified by the first buyer.

12. The method of claim 8, wherein the confirmation is based on at least a portion of the first creative having been presented in the user interface, the portion being specified by the first buyer.

13. The system of claim 8, wherein adjusting the first bid price further comprises:
applying a risk factor to the first bid price, the risk factor being configured to raise the first bid price and compensate for a probability that:
(i) the first bid is selected as the top-ranked bid; and
(ii) no confirmation is received for viewing of a first creative of the first buyer that is served to the ad space.

14. The system of claim 8, wherein the bids further comprise a second bid corresponding to a second buyer and a second bid price, the second bid price being a cost-per-impression price wherein the second buyer pays the second bid price when a creative for the second buyer is served to the ad space.

15. A storage device having instructions stored thereon that when executed by one or more computers perform operations comprising:
receiving from a client device a first notification of an ad space of an ad space inventory, the ad space being for presentation in a user interface of an application executing on the client device;
sending, to a plurality of bidders, a second notification requesting a bid on the ad space, each bidder representing a respective buyer;
receiving bids from the bidders, each bid associated with a respective buyer, a respective creative, and a respective bid price;
identifying a first bid of the received bids corresponding to a first buyer, a first bid price, and a first creative, wherein the first bid price being a cost-per-view price wherein the first buyer pays the first bid price only if the first creative is viewed wherein the first creative is associated with tracking code that is configured to analyze changes to a document object model to determine whether a particular location of the creative is presented in the user interface;
adjusting the first bid price based on a historical viewing rate of ad spaces of the ad space inventory;
ranking the bids according to respective bid prices wherein the first bid is ranked according to the adjusted first bid price;
selecting the first bid as a top-ranked bid and sending the first creative and associated tracking code to the client device; and
determining that a confirmation of viewing of the first creative by a user is received and, based thereon, recording a transaction comprising the seller, the first buyer, and the first bid price before adjustment, wherein the confirmation is generated by the tracking code.

16. (canceled)

17. The method of claim 15, wherein:
the confirmation is based on processing, by the user interface, the tracking code to generate one or more pixels for presentation in the ad space in the user interface.

18. The method of claim 15, wherein the confirmation is based on the first creative having been presented in the user interface for a time period that exceeds a time period specified by the first buyer.

19. The method of claim 15, wherein the confirmation is based on at least a portion of the first creative having been presented in the user interface, the portion being specified by the first buyer.

20. The storage device of claim 15, wherein adjusting the first bid price further comprises:
applying a risk factor to the first bid price, the risk factor being configured to raise the first bid price and compensate for a probability that:
(i) the first bid is selected as the top-ranked bid; and
(ii) no confirmation is received for viewing of a first creative of the first buyer that is served to the ad space.
